(19) United States
(12) Patent Application Publication
(10) Pub. No.: US 2026/0001526 A1
(43) Pub. Date: Jan. 1, 2026

(54) DEVICE AND METHOD WITH AUTONOMOUS PARKING CONTROL

(71) Applicant: Samsung Electronics Co., Ltd., Suwon-si (KR)

(72) Inventor: Joonwoo AHN, Suwon-si (KR)

(73) Assignee: Samsung Electronics Co., Ltd., Suwon-si (KR)

(21) Appl. No.: 18/984,692

(22) Filed: Dec. 17, 2024

(30) Foreign Application Priority Data
Jul. 1, 2024 (KR) 10-2024-0086402

(51) Int. Cl. B60W 30/06; B60W 50/00; G06V 10/82; G06V 20/58

(52) U.S. Cl. CPC B60W 30/06; B60W 50/00; G06V 10/82; G06V 20/586; B60W 2050/0031; B60W 2420/403; B60W 2710/20; B60W 2720/10; B60W 2720/24

(57) ABSTRACT

In one general aspect, an operating method of an electronic device includes: identifying a parking spot to park a moving object; inputting the parking spot and odometry information representing a position of the moving object relative to the parking spot to a first artificial intelligence (AI) model, the first AI model inferring a first output from the parking spot and the odometry information; controlling driving of the moving object based on the first output obtained by the first AI model; inputting an image obtained by a camera of the moving object to a second AI model, the second AI model inferring a second output from the image; and controlling the driving of the moving object to drive to the parking spot based on the second output obtained by the second AI model.

### CROSS-REFERENCE TO RELATED APPLICATIONS

This application claims the benefit under 35 USC § 119(a) of Korean Patent Application No. 10-2024-0086402, filed on Jul. 1, 2024, in the Korean Intellectual Property Office, the entire disclosure of which is incorporated herein by reference for all purposes.

### BACKGROUND

### 1. Field

The following description relates to a device and method with autonomous parking control.

### 2. Description of Related Art

The driving of a moving object, such as a vehicle or a mobile robot, by itself without a human operator may be referred to as autonomous driving. The parking of a moving object by itself without a driver or human operator may be referred to as autonomous parking. The autonomous driving and autonomous parking of the moving object may be controlled by an electronic device incorporated in the moving object. Autonomous driving or autonomous parking may be performed by using a module or an artificial intelligence (AI) model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operating method of an electronic device includes: identifying a parking spot to park a moving object; inputting the parking spot and odometry information representing a position of the moving object relative to the parking spot to a first artificial intelligence (AI) model, the first AI model inferring a first output from the parking spot and the odometry information; controlling driving of the moving object based on the first output obtained by the first AI model; inputting an image obtained by a camera of the moving object to a second AI model, the second AI model inferring a second output from the image; and controlling the driving of the moving object to drive to the parking spot based on the second output obtained by the second AI model.

The first output may be determined based on the parking spot and the odometry information, and the first output may include: an indication of whether the moving object reached a spot from which the moving object is able to be parked into the parking spot by a predetermined number of forward maneuvers and/or backward maneuvers, and steering and speed settings by which to control the moving object to find and drive to the spot.

The predetermined number may be one.

The controlling of the driving of the moving object and the inputting of the image by the camera to the second AI model may include: when it is determined that the moving object has reached the spot, inputting the image to the second AI model.

The operating method may further include: based on the first output, determining that the moving object has reached the spot, controlling the driving of the moving object based on the steering and the speed, updating the odometry information of the moving object driven after the moving object has driven based on the steering and the speed, and inputting the updated odometry information and the parking spot to the first AI model.

The second output may include steering and speed to control the moving object to drive to the parking spot determined based on the image obtained by the camera.

The parking spot may be determined based on odometry information of the moving object updated according to the driving of the moving object after the parking spot is initially identified to park the moving object.

The first AI model may be trained to output information about whether the moving object reaches a reference target spot in which the moving object is able to be parked in a reference parking spot by a predetermined number of forward maneuvers and/or backward maneuvers, and reference steering and reference speed to cause the moving object to find and drive to the reference target spot by receiving the reference parking spot and reference odometry information in a first training data set.

The second AI model may be trained to output reference steering and reference speed to cause the moving object to drive to a reference parking spot from a reference target spot from which the moving object is able to be parked into the reference parking spot by a predetermined number of forward maneuvers and/or backward maneuvers by receiving a reference image in a second training data set.

In another general aspect, an operating method of an electronic device includes: identifying a parking spot to park a moving object; inputting the parking spot and odometry information representing a position of the moving object relative to the parking spot to a first artificial intelligence (AI) model, the first AI model inferring a first output from the parking spot and the odometry information; controlling driving of the moving object based on the first output obtained by the first AI model; inputting an image obtained by a camera of the moving object to a second AI model, the second AI model inferring a second output from the image; and controlling the driving of the moving object to drive to the parking spot based on the second output obtained by the second AI model.

A non-transitory computer-readable storage medium may store one or more instructions that, when executed by a processor, cause the processor to perform any of the methods.

In another general aspect, an electronic device includes: at least one memory including instructions; and one or more processors configured to execute the instructions, wherein the instructions are configured to, when executed by the one or more processors, cause the one or more processors to: determine a parking spot; perform a first parking maneuver in a first direction by repeatedly: having a first neural network model infer from the parking spot a first output including at least a speed and a direction, driving the moving object according to the speed and steering direction, obtaining odometry of the moving object, and determining from the first output if a first condition is satisfied; and in response to determining that the first condition is satisfied, performing a second parking maneuver in a second direction opposite to the first direction by repeatedly: obtaining an image, having a second neural network model infer from the image a second output including a speed and steering direction, driving the moving object according to the speed and steering direction, and determining if the moving object has reached the parking spot.

The determining from the first output if the first condition is satisfied may include determining if the moving object can reach the parking spot from a current position of the moving object.

The second neural network may not use the determined parking spot to infer the second outputs.

The odometry information of the moving object may be determined based on sensors of the moving object.

The first parking maneuver may be performed without using the second neural network, and the second parking maneuver may be performed without using the first neural network.

The second outputs may each include steering and speed to control the moving object to drive toward the parking spot based on the image obtained by the camera.

The parking spot may be determined based on odometry information updated according to the driving of the moving object after the parking spot is initially identified to park the moving object.

The first neural network model may be trained to output information indicating whether the moving object has reached a reference target spot from which the moving object is able to be parked into a reference parking spot by a predetermined number of forward maneuvers and/or backward maneuvers, and reference steering and reference speed to cause the moving object to find and drive to the reference target spot by receiving the reference parking spot and reference odometry information in a first training data set.

The second neural network model may be trained to output reference steering and reference speed to cause the moving object to drive to a reference parking spot from a reference target spot from which the moving object is able to be parked into the reference parking spot by one forward maneuver or one backward maneuver.

Other features and aspects will be apparent from the following detailed description, the drawings, and the claims.

### BRIEF DESCRIPTION OF THE DRAWINGS

FIG. 1 illustrates an electronic device according to one or more embodiments.

FIG. 2 illustrates conventional module-based autonomous parking.

FIG. 3 illustrates conventional neural network-based autonomous parking.

FIG. 4 illustrates operations of an electronic device according to one or more embodiments.

FIG. 5 illustrates autonomous parking based on a first artificial intelligence (AI) model according to one or more embodiments.

FIG. 6 illustrates autonomous parking based on a second AI model according to one or more embodiments.

FIG. 7 illustrates training of the first AI model and the second AI model according to one or more embodiments.

FIG. 8 illustrates operations of an electronic device according to one or more embodiments.

FIG. 9 illustrates operations of an electronic device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

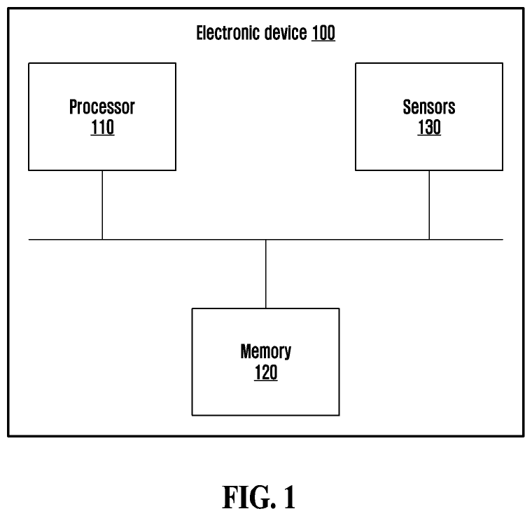

FIG. 1 illustrates an electronic device 100 according to one or more embodiments.

Referring to FIG. 1, the electronic device 100 may include a processor 110, a memory 120, and sensors 130 (e.g., camera(s), LiDAR(s), radar(s), inertia sensor(s), and/or the like). The processor 110, the memory 120, and the sensors may communicate with each other via a bus, a network on a chip (NoC), and peripheral component interconnect express (PCIe), for example. The electronic device 100 may be incorporated in a moving object.

As used herein, the term “moving object” refers to any moving object that is able to recognize a surrounding environment and autonomously drive itself using a device such as the electronic device 100, and may be, for example, a vehicle, a mobile robot, or a drone, as non-limiting examples.

As noted, the electronic device 100 may include a processor 110, which in practice may be one or more processors of possibly varying types, described later. The processor 110 may perform overall functions to control the electronic device 100 by executing programs and/or instructions stored in the memory 120. The processor 110 may be implemented as a central processing unit (CPU), a graphics processing unit (GPU), an application processor (AP), and/or the like, which is included in the electronic device 100, but examples are not limited thereto.

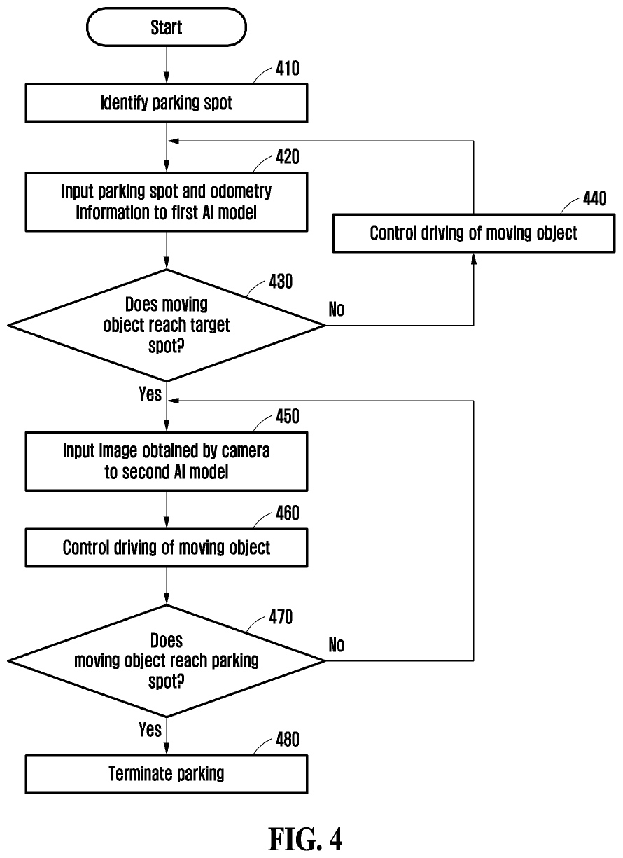

As noted, the electronic device 100 may include at least one memory 120. The memory 120 may be hardware for storing data processed in the electronic device 100. In addition, the memory 120 may store an application, a driver, and the like to be driven by the electronic device 100. In addition, the memory 120 may store instructions and/or programs executable by the processor 110. The memory 120 may include volatile memory (e.g., dynamic random access memory (DRAM)) and/or non-volatile memory. The memory 120 may include a non-transitory computer-readable storage medium. The non-transitory computer-readable storage medium may store one instructions executable by the processor 110. When the instructions are executed by the processor 110, the instructions are configured according to the description of FIGS. 4 to 8, the instructions may cause the electronic device 100 to perform the operations described with reference to FIGS. 4 to 8.

As noted, the electronic device 100 may include the sensors 130. The sensors 130 may include one or more cameras. The sensors 130 may include sensors configured to obtain odometry information of a moving object. For example, the sensors 130 may include a sensor configured to measure the rotation of a wheel, a sensor configured to measure an angle of a wheel, and a sensor configured to measure the acceleration and rotation of the moving object incorporated in the electronic device 100. However, this is an example and the present disclosure is not limited thereto.

The electronic device 100 may control autonomous driving and/or parking of a moving object. For example, the electronic device 100 may control forward parking, reverse parking, and parallel parking.

The electronic device 100 may identify a parking spot for parking a moving object. The electronic device 100 may control the moving object to park in the identified parking spot while minimizing trial and error. For example, when the electronic device 100 controls reverse parking of the moving object, the electronic device may control the driving of the moving object into an available parking spot (a target spot) by one backward movement after the parking spot is identified.

Conventionally, autonomous parking is performed based on a module or a neural network. Some aspects of conventional autonomous driving based on a module or a neural network are described next.

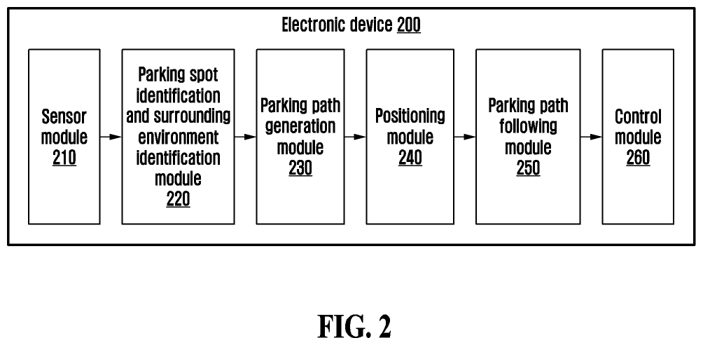

FIG. 2 illustrates an electronic device 200 configured to perform conventional module-based autonomous parking. Each module may be implemented as hardware or software.

The electronic device 200 may include a sensor module 210. The sensor module 210 may include a left camera, a right camera, a front camera, and a rear camera. The sensor module 210 may include four 128-channel, 82-channel, or 32-channel LiDAR sensors. The electronic device 200 may sense a surrounding environment of a moving object through the sensor module 210.

The electronic device 200 may include a parking spot identification (PSI) and surrounding environment identification (SEI) module 220. The PSI and SEI module 220 may identify a surrounding environment (e.g., an obstacle and an area where a moving object is able to drive) based on information received from the sensor module 210. The PSI and SEI module 220 may identify a parking spot into which the moving object can be parked based on the information received from the sensor module 210.

The electronic device 200 may include a parking path generation module 230. The parking path generation module 230 may generate a path for parking the moving object into the parking spot based on the surrounding environment and the parking spot identified by the PSI and SEI module 220. The parking path generation module 230 may be configured to try to minimize the transitions between forward and backward movement of the moving object by considering a non-holonomic system of the moving object, and may generate a path for parking the moving object into the parking spot through a shortest total moving distance.

The electronic device 200 may include a positioning module 240. The positioning module 240 may identify a position and a direction of the moving object relative to the path generated by the parking path generation module 230.

The electronic device 200 may include a parking path following module 250. The parking path following module 250 may, based on the path and the identified position and direction of the moving object relative to the path, determine the steering direction/angle and the speed of the moving object for the moving object to follow the path by reducing a position deviation and/or a direction deviation from the path.

The electronic device 200 may include a control module 260. The control module 260 may control the driving of the moving object based on the steering and speed determined by the parking path following module 250.

As described above, a linear chain of cooperation between modules may be involved with module-based autonomous driving. With this sensing-path-control chain, errors occurring in each module may be continuously accumulated. Eventually, parking may fail as the errors are accumulated. Alternatively, parking may succeed after several periods of trial and error. In other words, in the case of module-based autonomous parking, parking may be successful only when there is a small error or no errors in a result obtained by each module.

Specifically, an error of the positioning module 240 may be frequent and large. For example, when the positioning module 240 uses global positioning system (GPS) information to identify a position and a direction of a moving object relative to a path, an error may be large. This is because the GPS information may have a relatively large error from 1 m to 3 m. Correcting the error accumulation of module-based autonomous parking may require significant computing resources.

Conventional autonomous driving based on a neural network is described next.

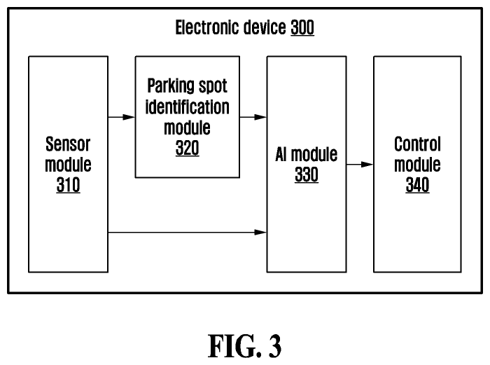

FIG. 3 illustrates a conventional neural network-based autonomous parking architecture. An electronic device 300 may be incorporated in a moving object. Each module of the electronic device 300 shown in FIG. 3 may be implemented as hardware or software.

Since the sensor module 310 may be the sensor module 210 of FIG. 2.

With neural network-based autonomous driving, only a parking spot identification module 320 may be used. In other words, a surrounding environment identification module may not be used. The parking spot identification module 320 may identify a parking spot based on information obtained by the sensor module 310.

The electronic device 300 may include an artificial intelligence (AI) module 330. The AI module 330 may include an AI model, for example, a neural network model. The AI module 330 may receive information indicating the identified parking spot and the information obtained by the sensor module 310. The AI module 330 may infer and output steering and speed to park the moving object into the parking spot.

The electronic device 300 may include a control module 340. The control module 340 may control the driving of the moving object based on the steering and speed provided by the AI module 330.

In the case of neural network-based autonomous parking, the number of modules may be significantly fewer than the case of module-based autonomous parking. However, for conventional neural network-based autonomous driving, identification of a parking spot may need to be iteratively performed. In other words, the parking spot may need to be identified again during parking based on an image obtained by a side camera according to the driving of the moving object, and such iterative parking spot identification may require significant computing resources.

In addition, since the parking spot needs to be iteratively identified, conventional neural network-based autonomous parking systems may not function in an end-to-end fashion.

Described next is a method of autonomous parking that involves identifying a parking spot, where the parking spot is only identified once at initiation of the autonomous parking. The method may involve performing the autonomous parking in two stages. The two stages may include a first stage (or first control loop) of controlling a moving object to drive to a target spot (an intermediate spot) from which to continue parking the moving object into the initially identified parking spot by a determined number (e.g., one) of forward and/or backward maneuvers, and a second stage of controlling the moving object to drive to the initially identified parking spot.

FIG. 4 illustrates operations of an electronic device according to one or more embodiments. The electronic device may have hardware components such as those of the electronic device 100. To summarize FIG. 4, the first control loop using a first AI model may be for a first maneuver (e.g., a forward maneuver), and the second control loop using a second AI model may be for a second maneuver (e.g., a backward maneuver).

In operation 410, the electronic device may initially identify a parking spot (note that “parking spot” is distinct from the to-be-discussed “target spot”, which may be an intermediate spot to be maneuvered-to and from which parking into the parking spot may be possible). In addition, the terms “target spot” and “parking spot” do not refer to physical locations per se, but rather are shorthand for data representing the corresponding physical locations. For example, either spot may be a location in a 2D model maintained by the electronic device, an image location in a BEV image, a distance and heading relative to the moving object, and so forth.

The electronic device may identify the parking spot when entering an autonomous parking mode or starting an autonomous parking procedure. The electronic device may identify the parking spot based on information obtained by the sensors 130. For example, the electronic device may identify the parking spot based on an image obtained by at least one side camera. As described below, to park the moving object, the parking spot may be used to determine updated odometry information according to the driving of the moving object after the parking spot is initially identified. Odometry information may include pose and/or position information of the moving object. The odometry information may be obtained using known techniques, depending on the type of sensor data available. For example, odometry information can be obtained by information such as wheel angle and/or rotation, image-based scene reconstruction, geolocation data, inertia data, or the like.

Further regarding the identifying of the parking spot, a parking spot may be initially identified based on images captured by the cameras of the moving object when parking begins. After the moving object starts moving, the odometry information may be updated as the moving object moves, and the position of the parking spot, relative to the moving object, is determined based on the updated odometry information. In other words, while the initial identification of the parking spot can be determined based on images acquired by the moving object's cameras, once the moving object starts moving, the updated odometry information, rather than images, may be used to identify the location of the parking spot.

In operation 420, the electronic device may input the parking spot and the odometry information to the first AI model.

The odometry information may be obtained by signals from one or more of the sensors, possibly of different types. The odometry information may represent a position of the moving object relative to the parking spot. The odometry information may represent a position and a posture (direction/orientation in 2 or possibly 3 spatial dimensions) of the moving object relative to the parking spot.

The first AI model may be a deep learning-based model, e.g., a neural network model, as a non-limiting example. When receiving the parking spot and the odometry information, the first AI model may output a first output, which may include information about/indicating whether the moving object is positioned at a target spot (discussed next). The first output may include steering data and speed data. To elaborate, as mentioned above, the first AI model can output a value (e.g., a probability) indicating whether the moving object has reached the target spot. In other words, the first AI model can output the probability that the moving object's current position has reached a target spot where it can reverse into the parking spot in one motion, each time the moving object moves. Thus, the first AI model does not determine whether the moving object has reached a predetermined target spot, but rather, such determination can be seen as the process of the moving object finding a target spot where it can reverse into the parking spot in one motion using the parking spot and odometry information.

The target spot may be a spot from which the moving object is able to be parked by a determined/minimal number (e.g., one) of forward and/or backward maneuvers. The number may be one, and the target spot may be such that it allows the moving object to be parked into the parking spot with one forward and/or backward maneuver from the target spot. In other words, the target spot may allow for minimal trial and error (e.g., a minimal number of forward or backward maneuvers). If the moving object has reached the target spot, the first AI model may detect the same and output “True”. If the moving object has not reached the target spot, the first AI model may detect the same and output “False”. As used herein, “maneuver” refers to total travel in one driving direction (e.g., forward or backward) by a series of incremental movements/motions. For example, a forward maneuver may be the total forward travel from a point of entering an autonomous parking mode to a point of starting a reverse maneuver (e.g., reaching the target spot), and a reverse maneuver may be the total backward travel from a point of starting the reverse maneuver (e.g., the target spot) until a stopping point (e.g., the parking spot). That is to say, a maneuver (a forward maneuver or a backward maneuver) is a total movement in a same direction (forward or backward) according to a sequence of individual movements, in the same direction (forward or backward), per respective model-outputted steering-speed controls.

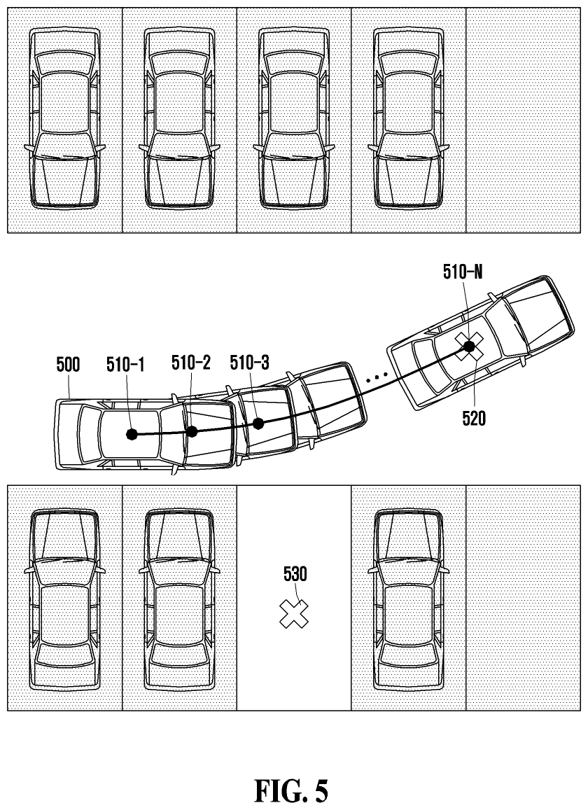

Although the term “target spot” is used herein, the term does not refer to a specific predetermined spot towards which the moving object drives on a path towards. Rather, the “target spot” is a hypothetically existing spot that the moving object seeks to find during a maneuver (e.g., a forward maneuver, as shown in FIG. 5). The target spot may be thought of as a to-be-found spot that satisfies a condition, which may be, for example, the condition may be that the spot has a sufficient probability of the moving object being to maneuver (e.g., reverse maneuver) to the parking spot from the target spot. Therefore, although the target spot may be described as existing at the start of an autonomous parking method, it is not a specific spot that is being steered towards, rather, it is a spot being searched for. Description of checking for whether “the target spot” has been reached refers to determining whether the moving object has reached a spot satisfying the condition, namely, ability to maneuver into the previously determined parking spot.

In some embodiments, the first AI model may output a value (e.g., a probability) representing whether (or how likely it is that) the moving has object reached the target spot (i.e., how likely it is that the moving object can maneuver into the parking spot from its current spot). If the value exceeds a threshold value, the first AI model may output “True” (or its output may be interpreted as “True”). If the value is less than or equal to the threshold value, the first AI model may output “False” (or its output may be interpreted as “False”).

The steering (e.g., wheel angle, steering angle, etc.) and speed may be used for the moving object to find and drive towards a spot likely to be the target spot. In other words, the electronic device may control the moving object to find and drive to the target spot based on the steering and speed.

In operation 430, the electronic device may determine whether the moving object has reached a spot that meets the condition of being the target spot. The electronic device may determine whether the moving object has reached the target spot based on the output of the first AI model, that is to say, based on the information indicating whether the moving object has reached a spot (the target spot) from which parking can be completed with another maneuver. For example, when the first AI model outputs “True” (or a value corresponding thereto), the electronic device may determine that the moving object has reached a spot that can function as the target spot. For example, when the first AI model outputs “False” (or a value indicating the same), the electronic device may determine that the moving object has not reached a spot that can function as the target spot.

In the “False” case when the electronic device determines that the moving object has not reached the target spot, the electronic device may perform operation 440 and control the driving of the moving object (perform an incremental movement). In the “True” case when the electronic device determines that the moving object has reached the target spot, the electronic device may stop using the first AI model and may begin using a second AI model, starting with performing operation 450.

Regarding operation 440 of controlling driving of the moving object (performing a movement), the electronic device may control the driving of the moving object based on the steering and speed included in the most recent first output (of the current iteration of the first control loop). In addition, the electronic device may update the odometry information, and the updating of the odometry information may be based on the latest information obtained by the sensors (or by information on the movement moving object or the previously driven steering and speed). After updating the odometry information, the electronic device may repeat the first control loop by again performing operation 420. In other words, the electronic device may input the parking spot and the updated odometry information to the first AI model.

However, obtained, the updated odometry information may represent a relative position (and/or a position and posture) of the moving object after it has been driven based on the steering and speed (as determined based on the parking spot).

To summarize, in the first stage, the electronic device may iteratively perform operations 420, 430, and 440 until the moving object reaches a spot determined to satisfy the condition of being the target spot. The electronic device may iteratively perform operations 420, 430, and 440 at a predetermined interval. In one implementation, the electronic device may iteratively perform operations 420, 430, and 440 at a specific time interval (e.g., every 0.05 seconds). In another implementation, the electronic device may iteratively perform operations 420, 430, and 440 at a predetermined distance interval, e.g., each time the moving object has moved a specific distance (e.g., 30 cm). The electronic device may iteratively perform operations 420, 430, and 440, until the moving object is determined to have reached a spot that meets the condition of being the target spot, after which the electronic device may move to the second stage (a control loop using the second AI model), starting with performing operation 450.

Accordingly, although the moving object drives, the initially identified parking spot may be continuously used as a parking guide using the updated odometry information without the need to identify the parking spot again using the sensors. Accordingly, the present disclosure may correspond to an end-to-end system, unlike conventional neural network-based autonomous parking systems (e.g., the one described earlier). End-to-end autonomous driving may involve using sensor data as input and producing low-level control actions (e.g., movements) as output. In contrast to end-to-end autonomous driving, conventional autonomous driving may provide the output of each component, such as bounding boxes and vehicle trajectories, directly into subsequent modules.

In operation 450, the electronic device may input an image obtained by the camera to the second AI model. In some cases the parking spot may not be used by the second AI model.

When the electronic device controls the moving object to perform a forward parking maneuver, the image obtained by the camera may be an image obtained by a front camera. When the electronic device controls the moving object to perform reverse parking maneuver, the image obtained by the camera may be an image obtained by a rear camera. When the electronic device controls the moving object to perform side parking maneuver (parallel parking), the image obtained by the camera may be an image obtained by a front camera or a rear camera (or another suitable camera).

The second AI model may receive the image obtained by the camera and may output a second output. The second output may include steering and speed of the moving object to park the moving object into the parking spot based on (e.g., inferred from) the image obtained by the camera.

In operation 460, the electronic device may control the driving of the moving object. Specifically, the electronic device may control the driving of the moving object based on the second output, i.e., based on the steering and speed of the second output.

In operation 460, the electronic device may determine whether the moving object has reached the parking spot (e.g., whether its location and/or posture match the parking spot).

When the electronic device determines that the moving object has not reached the parking spot, the electronic device may perform operation 450. When the electronic device determines that the moving object has reached the parking spot, the electronic device may perform operation 480.

To summarize, the electronic device may iteratively perform operations 450, 460, and 470 until the moving object reaches the parking spot. When the moving object reaches the parking spot, the electronic device may perform operation 480. In one implementation, the electronic device may iteratively perform operations 450, 460, and 470 at a specific time interval (e.g., every 0.05 seconds). In another implementation, the electronic device may iteratively perform operations 450, 460, and 470 each time the moving object moves by a specific distance (e.g., 30 cm). The electronic device may iteratively perform operations 450, 460, and 470 until the moving object reaches the parking spot, then the electronic device may perform operation 480.

In operation 480, the electronic device may terminate parking with the autonomous parking mode.

Next, the operations described with reference to FIG. 4 are described further.

FIG. 5 illustrates autonomous parking based on a first artificial intelligence (AI) model according to one or more embodiments.

FIG. 5 shows a moving object 500 performing reverse parking. However, the following description is applicable to the moving object 500 performing forward parking or side/parallel parking.

Referring to FIG. 5, positions 510-1 to 510-N are illustrated. The positions 510-1 to 510-N are positions of the moving object 500 as the moving object 500 drives. The position 510-1 is a position in which the moving object starts autonomous parking. The position 510-N is a position the moving object 500 has driven towards and finally reached a target spot 520. In other words, the moving object 500 may start from the position 510-1 and may move to the position 510-N.

An electronic device incorporated in the moving object 500 may identify a parking spot 530 at the position 510-1. The electronic device may identify the parking spot 530 based on sensors. The parking spot 530 may be identified based on a top-view (birds-eye view (BEV)) image obtained by converting an image obtained by a side camera (and/or image(s) of other camera(s)). For example, the electronic device may (i) recognize, in the top-view image, intersecting points in which a parallel parking lines (e.g., the lengthwise parking lines of the parking area having the parking spot 530) and a vertical parking line intersect, and may (ii) identify the parking spot 530 based on a positional relationship of the intersecting points. When the electronic device identifies multiple parking spots, the electronic device may identify a closest spot as the target parking spot 530.

At the position 510-1, the electronic device may obtain odometry information based on the sensors (or obtained by any means). The odometry information may represent a position of the moving object 500 relative to the parking spot 530.

The electronic device may input the odometry information and an indication of the parking spot 530 to the first AI model. The first AI model may output (infer) a first output based on the parking spot 530 and the odometry information. The first output may include (i) information indicating whether the moving object 500 has reached a spot that meets the condition of being the target spot 520 (for the purpose of parking the moving object 500 in the parking spot 530 by a predetermined number (hereinafter, one) of forward maneuvers and/or backward maneuvers), and (ii) steering and speed to control the moving object 500 such that it is likely to find (drive to) a spot that meets the condition of being the target spot 520. Further regarding the information indicating whether the moving object 500 has reached a spot that meets the condition of being the target spot 520, such information may include data indicating whether the moving object has reached the target spot, as well as steering and speed information. In this case, the steering and speed information may represent the steering and speed required for the moving object to move toward the target spot if its current position is not the target spot. For example, if the moving object has reached the target spot (e.g., when the probability exceeds a threshold), both the steering and speed information may be 0 (or close to 0). However, if the moving object has not reached the target spot (e.g., when the probability is below the threshold), the steering and speed information may have values that guide the object to drive toward the predicted area where the target spot is expected to be.

For example, since in the example of FIG. 5 the moving object 500 is performing reverse parking (starting with a forward maneuver), the first AI model may output information (e.g., a probability) about whether the moving object 500 is able to park into the parking spot 530 by one backward maneuver from the initial position 510-1. For example, since the parking spot 530 is on the right side of the moving object 500 (which may be determined from a top-view (BEV) image), the first AI model may output steering and speed for the moving object 500 to drive forward and in a left direction/heading in which a the target spot (e.g., target spot 520) is highly likely to be located. In other words, the moving object 500 does not drive along a specific path but rather drives incrementally towards a spot in which a target spot (a point from which a reverse maneuver to the parking spot is possible) is highly likely to exist, according to the output of the first AI model.

If the electronic device determines, from the first output, that the moving object 500 is unable to park in the parking spot 530 by one backward maneuver from its position 510-1 (i.e., does the current position, position 510-1, meet the condition of being the target spot), the electronic device may control driving of the moving object 500 based on the speed and steering of the first output; driving based on the speed and steering of the first output may result in the moving object 500 being at position 510-2.

At the position 510-2, the electronic device may update the odometry information of the moving object 500. The updated odometry information and the parking spot 530 may be inputted to the first AI model. The first AI model may output (e.g., infer) a new/updated first output (e.g., new speed and steering) based on the updated odometry information and the parking spot 530.

If the electronic device determines, based on the first output, that the moving object 500 is unable to be parked in the parking spot 530 by one backward maneuver from the position 510-2 (i.e., the position 510-2 does meet the condition of being the target spot), then the electronic device may control the moving object 500 based on the speed and steering of the first output; driving based on the speed and steering of the new/updated first output may cause the moving object 500 to reach the position 510-3.

The operations of the electronic device described above may be iteratively performed until, as described next, it is determined, at position 510-N that position 510-N meets the condition of being a/the target spot 520 (i.e., the moving target is able to be reversed into the parking spot).

When the moving object 500 reaches the position 510-N, the electronic device may again update the odometry information. The electronic device may input this updated odometry information and the parking spot 530 to the first AI model. The first AI model may output (infer) a new first output based on the updated odometry information (current location and pose of the moving object 500) and the parking spot 530.

The electronic device may (i) determine that the moving object 500 has reached a spot from which it can park into the parking spot 530 with a reverse maneuver (i.e., has reached a spot that becomes the target spot 520), and may make that determination (ii) based on the information of the first output. When it is determined that the moving object 500 reached a spot from which the parking spot 530 can be reversed-to (e.g., a spot that satisfied the condition of being the target spot 520), the electronic device may begin controlling the autonomous parking of the moving object 500 using the second AI model. Autonomous parking based on the second AI model is described next.

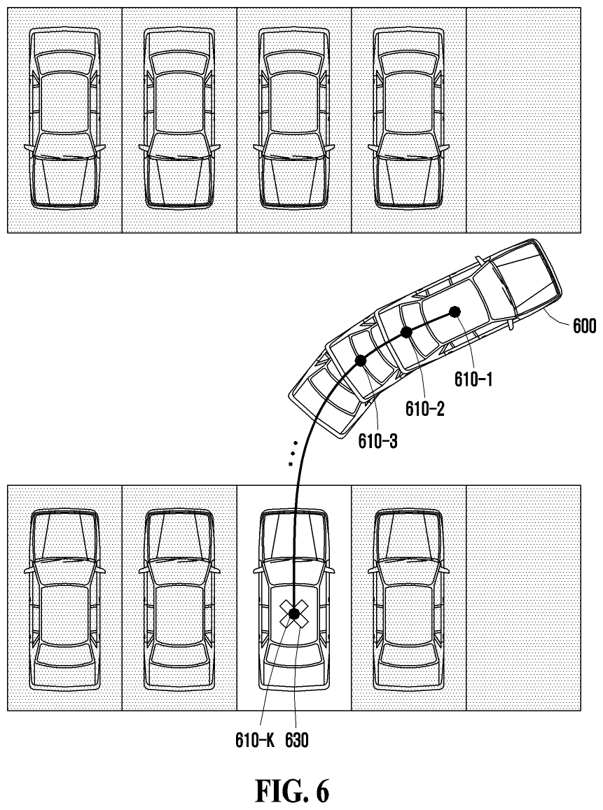

FIG. 6 illustrates autonomous parking based on the second AI model according to one or more embodiments.

Although FIG. 6 outlines operations by which a moving object 600 may perform reverse parking into a target spot (e.g., a position 610-1), the parking operations are generally applicable to forward and side parking.

Referring to FIG. 6, positions 610-1 to 610-K are illustrated. The positions 610-1 to 610-K represent respective positions of the moving object 600 as the moving object 600 drives from the target spot 520 to a parking spot 630 (at each iteration, an image may be checked until the moving object reaches the parking spot). The position 610-1 represents an initial position of the moving object 600 when it starts backward movement. The position 610-K is a position of the moving object 600 when it reaches the parking spot 630 after K iterations.

At each iteration of using the second AI model, including at position 610-K, the electronic device may input an image obtained by a rear camera mounted on the moving object 600 to the second AI model. When the moving object 600 attempts forward parking, images inputted to the second AI model may be obtained by a front camera.

At each iteration, the second AI model may output a second output based on the corresponding image obtained by the rear camera. The second output may include steering and speed (determined based on the image) to drive the moving object 600 towards the parking spot 630.

The electronic device may control the driving of the moving object 600 based on the steering and speed of the second output. The moving object 600 may be at the position 610-2 end up (e.g., after a predetermined time or distance traveled) based on the steering and speed of the second output.

At the position 610-2, the electronic device may determine whether the moving object 600 has reached the parking spot 630. When the moving object 600 has not reached the parking spot 630, the electronic device may input, to the second AI model, a new image obtained by the rear camera at the position 610-2. Regarding the determination of whether the moving object 600 has reached the parking spot 630, the second AI model may output a probability. The moving object may compare the probability to the threshold. If the probability is larger than the threshold, the moving object may determine that it has reached the parking spot. Alternatively, whether the moving object has reached the parking spot may be determined based on whether the steering and speed outputs of the second AI model are zero. For example, if the steering and speed are zero (or close to zero), it can be judged that the moving object has reached the parking spot.

The second AI model may output/infer the second output based on the image obtained by the rear camera at the position 610-2. The second output may include the steering and speed of the moving object 600 to drive towards the parking spot 630, where the steering and speed are determined based on the image obtained by the rear camera at the position 610-2.

The electronic device may control the driving of the moving object 600 based on the steering and speed of the second output. The moving object 600 may move according steering and speed of the second output and end up at the position 610-3 (e.g., after a predetermined interval time has elapsed or a predetermined distance has been traveled).

The operation of the electronic device described above may be iteratively performed until the moving object 600 reaches the parking spot 630.

When the moving object 600 reaches the position 610-K, the electronic device may terminate parking by determining that the moving object 600 has reached the parking spot 630.

Training of the first AI model and the second AI model of FIG. 5 is described next.

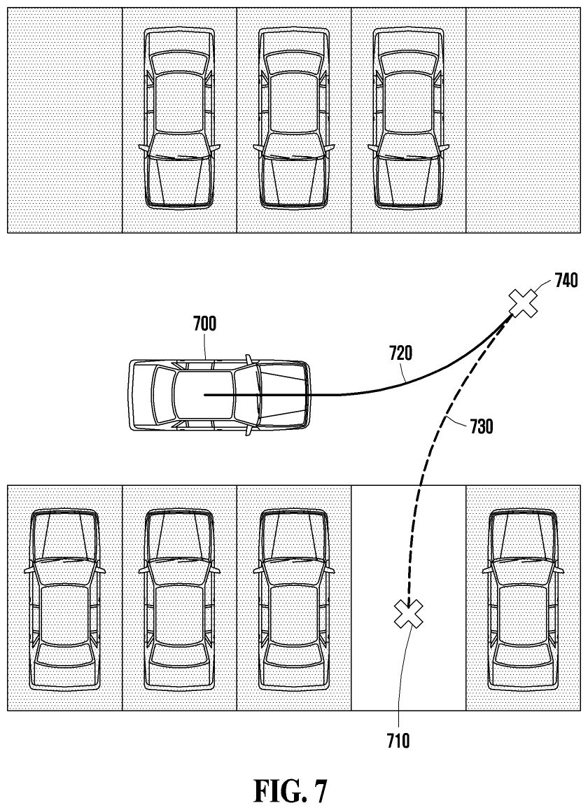

FIG. 7 illustrates training of the first AI model and the second AI model according to one or more embodiments.

A first training data set may be used for training the first AI model, and a second training data set used for training the second AI model.

The first AI model and the second AI model may be deep learning-based AI models. For example, either model may be a neural network of layers of interconnected nodes having weights of connections that are set by the aforementioned training, each model may have an input layer of input nodes to receive an input and an output layer of output node(s) to output an inference performed by the model on an input. However, this is an example and the present disclosure is not limited thereto. The first AI model and the second AI model may be trained through imitative learning. However, this is an example and the present disclosure is not limited thereto.

The electronic device may generate the first training data set and the second training data set using a module-based autonomous driving method to show a clear pattern between an input and an output to train the AI model. However, this is an example and the present disclosure is not limited thereto.

A method of generating the first training data set and the second training data set through reverse parking of a moving object 700 is described next. However, the following description is applicable to cases of generating the first training data set and the second training data set through forward parking and side parking.

The electronic device may identify a reference parking spot 710 based on a sensors of the moving object 700. The reference parking spot 710 is a spot used for generating training data. The electronic device may identify areas other than a parking area corresponding to the reference parking spot 710 and a parking lot road (shown as shaded area) regardless of whether an obstacle exists therein. The identified shaded area may be an area where a vehicle is unable to drive.

The electronic device may generate a shortest path (in other words, a target path) to park the moving object 700 in the reference parking spot 710. For example, the electronic device may generate paths to park the moving object 700 in the reference parking spot 710 using a parking path generative algorithm and may select the shortest path. According to an embodiment, the electronic device may generate the paths based on a target-tree rapid exploring random tree (RRT) algorithm. However, this is an example and the present disclosure is not limited thereto.

The target path may include a first path 720 from a spot in which parking begins to a reference target spot 740 and a second path 730 from the reference target spot 740 to the reference parking spot 710. The reference target spot 740 is also a spot used to generate training data.

The electronic device may cause the moving object 700 to drive along the first path 720 according to steering and speed obtained based on a module and may obtain reference odometry information and the reference parking spot 710. In addition, the electronic device may obtain information about whether the moving object 700 reaches the reference target spot 740 while the moving object 700 drives along the first path 720. In addition, the electronic device may obtain reference steering and reference speed while the moving object 700 drives along the first path 720. The reference odometry information, the reference steering, and the reference speed may represent odometry information, steering, and speed used to generate training data, respectively.

The electronic device may generate the first training data by labeling the reference steering and the reference speed at reference odometry information and the reference parking spot 710.

When the moving object 700 reaches the reference target spot 740, the electronic device may cause the moving object 700 to drive along the second path 730 according to the steering and speed obtained based on a module. The electronic device may obtain an image through a rear camera while the moving object 700 drives along the second path 730. According to an embodiment, when the moving object 700 performs forward parking, the electronic device may obtain an image through a front camera. According to an embodiment, when the moving object performs side parking, the electronic device may obtain an image through the front camera and/or the rear camera.

The electronic device may obtain the reference steering and the reference speed of the moving object 700 while the moving object 700 drives along the second path 730.

The electronic device may generate second training data by labeling the reference steering and the reference speed on the image obtained by the rear camera.

In other words, the electronic device may generate both the first training data and the second training data by performing module-based autonomous parking once. The electronic device may generate the first training data set and the second training data set by obtaining pieces of first training data and pieces of second training data using the method described above in various parking environments. This training approach may be repeated for other parking conditions, other moving objects, etc., and multiple parking scenarios may be included in the training data sets.

The electronic device may train the first AI model based on the first training data set. In other words, the first AI model may be trained to output information about whether the moving object has reached the reference target spot in which the moving object is able to be parked in the reference parking spot by a predetermined number of forward movements and/or backward maneuvers, and the reference steering and the reference speed to cause the moving object to find and drive to the reference target spot by receiving the reference target spot and the reference odometry information in the first training data set.

The electronic device may train the second AI model based on the second training data set. The second AI model may be trained to output the reference steering and the reference speed to cause the moving object to drive to a reference parking spot from a reference target spot in which the moving object is able to be parked in the reference parking spot by a predetermined number of forward movements and/or backward movements by receiving a reference image in the second training data set.

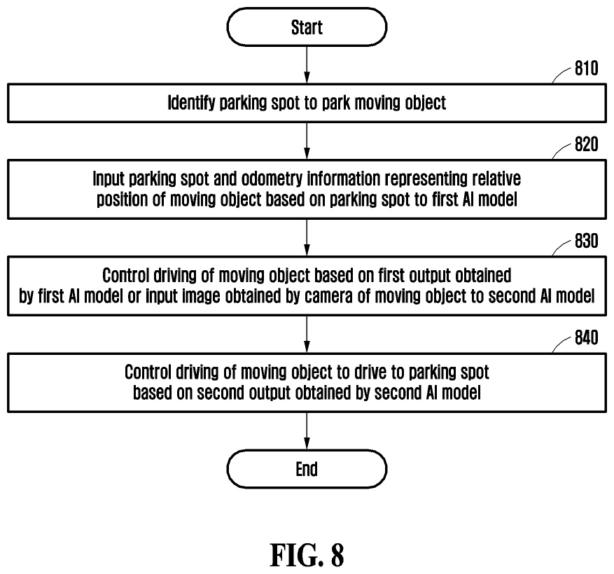

FIG. 8 illustrates operations of an electronic device according to one or more embodiments.

In operation 810, the electronic device may identify a parking spot to park a moving object.

In operation 820, the electronic device may input, to the first AI model, the parking spot and odometry information representing a position of the moving object relative to the parking spot.

In operation 830, the electronic device may control the driving of the moving object based on a first output obtained by the first AI model or may input an image obtained by a camera of the moving object to the second AI model.

In operation 840, the electronic device may control the driving of the moving object to drive the moving object to the parking spot based on a second output obtained by the second AI model.

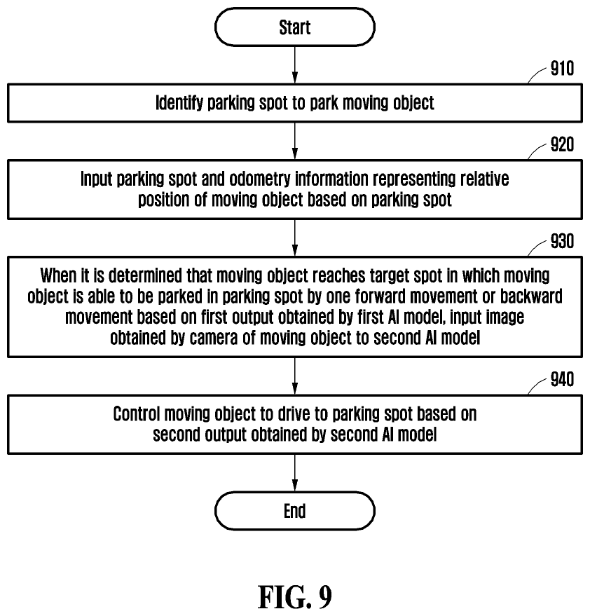

FIG. 9 illustrates operations of an electronic device according to one or more embodiments.

In operation 910, the electronic device may identify a parking spot to park a moving object.

In operation 920, the electronic device may input, to the first AI model, the parking spot and odometry information representing a position of the moving object relative to the parking spot to the first AI model.

In operation 930, when it is determined that the moving object is able to be parked in the parking spot by one forward movement or backward movement based on a first output obtained by the first AI model, the electronic device may input an image obtained by a camera of the moving object to the second AI model.

In operation 940, the electronic device may control the moving object to drive to the parking spot based on a second output obtained by the second AI model.

The embodiments described herein may be implemented using a hardware component, a software component (physical code/instructions) and/or a combination thereof. A processing device may be implemented using one or more general-purpose and/or special-purpose processors, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include processors, or a single processor and a single controller. In addition, different processing configurations are possible, such as parallel processors.

The software may include a computer program, code, instructions, or some combination thereof, to independently or collectively instruct or configure the processing device to operate as described above. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The computing apparatuses, the vehicles, the electronic devices, the processors, the memories, the image sensors, the vehicle/operation function hardware, the autonomous/assisted driving systems, the displays, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operating method of an electronic device, the operating method comprising:
identifying a parking spot to park a moving object;
inputting the parking spot and odometry information representing a position of the moving object relative to the parking spot to a first artificial intelligence (AI) model, the first AI model inferring a first output from the parking spot and the odometry information;
controlling driving of the moving object based on the first output obtained by the first AI model;
inputting an image obtained by a camera of the moving object to a second AI model, the second AI model inferring a second output from the image; and
controlling the driving of the moving object to drive to the parking spot based on the second output obtained by the second AI model.

2. The operating method of claim 1, wherein the first output is determined based on the parking spot and the odometry information, and wherein the first output comprises:
an indication of whether the moving object reached a spot from which the moving object is able to be parked into the parking spot by a predetermined number of forward maneuvers and/or backward maneuvers, and
steering and speed settings by which to control the moving object to find and drive to the spot.

3. The operating method of claim 2, wherein the predetermined number is one.

4. The operating method of claim 2, wherein the controlling of the driving of the moving object and the inputting of the image by the camera to the second AI model comprises:
when it is determined that the moving object reaches the spot, inputting the image to the second AI model.

5. The operating method of claim 2, further comprising:
based on the first output, determining that the moving object has reached the spot, controlling the driving of the moving object based on the steering and the speed,
updating the odometry information of the moving object driven after the moving object has driven based on the steering and the speed, and
inputting the updated odometry information and the parking spot to the first AI model.

6. The operating method of claim 1, wherein the second output comprises steering and speed to control the moving object to drive to the parking spot determined based on the image obtained by the camera.

7. The operating method of claim 1, wherein the parking spot is determined based on odometry information of the moving object updated according to the driving of the moving object after the parking spot is initially identified to park the moving object.

8. The operating method of claim 1, wherein the first AI model is trained to output information about whether the moving object reaches a reference target spot in which the moving object is able to be parked in a reference parking spot by a predetermined number of forward maneuvers and/or backward maneuvers, and reference steering and reference speed to cause the moving object to find and drive to the reference target spot by receiving the reference parking spot and reference odometry information in a first training data set.

9. The operating method of claim 1, wherein the second AI model is trained to output reference steering and reference speed to cause the moving object to drive to a reference parking spot from a reference target spot from which the moving object is able to be parked into the reference parking spot by a predetermined number of forward maneuvers and/or backward maneuvers by receiving a reference image in a second training data set.

10. An operating method of an electronic device, the operating method comprising:
identifying a parking spot to park a moving object;
inputting the parking spot and odometry information representing a position of the moving object relative to the parking spot to a first artificial intelligence (AI) model, the first AI model inferring a first output from the parking spot and the odometry information;
controlling driving of the moving object based on the first output obtained by the first AI model;
inputting an image obtained by a camera of the moving object to a second AI model, the second AI model inferring a second output from the image; and
controlling the driving of the moving object to drive to the parking spot based on the second output obtained by the second AI model.

11. A non-transitory computer-readable storage medium storing one or more instructions that, when executed by a processor, cause the processor to perform the method of claim 1.

12. An electronic device comprising:
at least one memory comprising instructions; and
one or more processors configured to execute the instructions,
wherein the instructions are configured to, when executed by the one or more processors, cause the one or more processors to:
determine a parking spot;
perform a first parking maneuver in a first direction by repeatedly: having a first neural network model infer from the parking spot a first output comprising at least a speed and a direction, driving the moving object according to the speed and direction, obtaining odometry of the moving object, and determining from the first output if a first condition is satisfied; and
in response to determining that the first condition is satisfied, performing a second parking maneuver in a second direction opposite to the first direction by repeatedly: obtaining an image, having a second neural network model infer from the image a second output comprising a speed and direction, driving the moving object according to the speed and direction, and determining if the moving object has reached the parking spot.

13. The electronic device of claim 12, wherein determining from the first output if a first condition is satisfied comprises determining if the moving object can reach the parking spot from a current position of the moving object.

14. The electronic device of claim 13, wherein the second neural network does not use the determined parking spot to infer the second outputs.

15. The electronic device of claim 13, wherein the odometry information of the moving object is determined based on sensors of the moving object.

16. The electronic device of claim 13, wherein the first parking maneuver is performed without using the second neural network, and the second parking maneuver is performed without using the first neural network.

17. The electronic device of claim 12, wherein the second outputs each comprise steering and speed to control the moving object to drive toward the parking spot based on the image obtained by the camera.

18. The electronic device of claim 12, wherein the parking spot is determined based on odometry information updated according to the driving of the moving object after the parking spot is initially identified to park the moving object.

19. The electronic device of claim 12, wherein the first neural network model is trained to output information indicating whether the moving object has reached a reference target spot from which the moving object is able to be parked into a reference parking spot by a predetermined number of forward maneuvers and/or backward maneuvers, and reference steering and reference speed to cause the moving object to find and drive to the reference target spot by receiving the reference parking spot and reference odometry information in a first training data set.

20. The electronic device of claim 12, wherein the second neural network model is trained to output reference steering and reference speed to cause the moving object to drive to a reference parking spot from a reference target spot from which the moving object is able to be parked into the reference parking spot by one forward maneuver or one backward maneuver.
